(19) United States
(12) Patent Application Publication
(10) Pub. No.: US 2022/0155617 A1
(43) Pub. Date: May 19, 2022

(54) Method of Integrating an Electronic Device Into an Eyeglass Frame, and Electronic Glasses

(71) Applicant: Morrow N.V., Gent (BE)

(72) Inventors: Jelle De Smet, Zwijnaarde (BE); Tim Ruytjens, Mortsel (BE); Phil Madden, Braschaat (BE); Wouter Woestenberghs, Wachtebeke (BE); Philip Ekkels, Drongen (BE)

(21) Appl. No.: 17/430,417

(22) PCT Filed: Feb. 17, 2020
(86) PCT No.: PCT/EP2020/054132

§ 371 Date: Aug. 12, 2021

(30) Foreign Application Priority Data
Feb. 15, 2019 (NL) 2022592

(51) Int. Cl. G02C 11/00; G02C 5/14; G02C 5/08

(52) U.S. Cl. CPC G02C 11/10; G02C 5/08; G02C 5/146

(57) ABSTRACT

Example embodiments relate to methods of integrating an electronic device into an eyeglass frame, and electronic glasses. One example set of electronic glasses is configured to be provided with at least one electro-optical component formed by an electro-active lens. The electronic glasses include an eyeglass frame that includes a first temple and a second temple, which include a first front temple part and a second front temple part, respectively. The electronic glasses also include a front part. The front part includes a left eyepiece for a left electro-active lens, a right eyepiece for a right electro-active lens, a bridge connecting the left and right eyepieces, and a groove. In addition, the electronic glasses include an electronic device. The electronic glasses further include a flexible cable arranged in the groove. Additionally, the electronic glasses include closure measures that include a sealing element.

The present disclosure relates to a method of integrating an electronic device into an eyeglass frame, to electronic glasses, to an electronic pre-assembly for integration into an eyeglass frame suited therefor, and to a kit for integration of electronics into such an eyeglass frame.

Many types of electronic glasses, wherein an electronic device is integrated into an eyeglass frame, are available. In some of these glasses, an electronic device is merely attached to a frame: for instance, US 2008/0013041 discloses an integration of a music player into the frame of a pair of spectacles. In others, the electronic device is more closely connected to the eyeglass function: for instance, glasses are known wherein a camera is integrated in such a way that a user can photograph or film what they are looking towards. In yet other electronic glasses, the electronic device interacts with the lenses in the eyeglasses: this is for instance the case with ‘active’ 3D glasses, in which the left and right lens are blocked in an alternating fashion, and with other types of electro-active lenses.

In a majority of the existing electronic glasses, the electronics are distributed on either side of the front part of the frame: for instance, a power source might be arranged on one side and control electronics on the other side. This also means that a connecting cable is required at least for power transfer and in many cases also information transfer. Such a cable must then be integrated in some way along or through the front part of the frame.

There are a number of challenges when integrating an electronic device into an eyeglass frame. A first is that the frame must be adapted to accommodate the electronic device: this may lead to a frame that is suitable only for the integration of one particular electronic device, to undesirable bulkiness, and/or to an unappealing aesthetic result. A second challenge is that preferably the electronics are integrated in a fairly robust manner, yet it is also desirable for the frame to be foldable. A third challenge is that the electronic device is preferably protected against moisture intrusion, yet at the same time it may be advantageous to be able to replace or access the electronic device. It is an object of the present disclosure to address at least some of these challenges.

In particular, it is an object of the disclosure to provide a method to integrate electronics into an eyeglass frame in a robust manner, with minimal bulkiness, wherein the electronics are substantially protected from moisture intrusion, and preferably wherein the electronic device may removed and replaced, for instance by an updated version or by an electronic device having more or different functionality.

This object and/or other objects may be at least partially achieved by a method of integrating an electronic device into an eyeglass frame configured to provided with at least one electro-optical component, the method comprising:

providing an eyeglass frame comprising a front part, a first temple and a second temple,
wherein said temples each comprise a front temple part, of which one end is attached to a side of the front part, and a rear temple part,
wherein the other ends of the front temple parts are attached to the respective rear temple parts so that the front temple parts and rear temple parts are movable with respect to each other;
wherein a first front temple part has a first cavity, a second front temple part has a second cavity and the front part has a groove extending between the first cavity of the first front temple part and the second cavity of the second temple part;

providing an electronic device comprising a first device part, a second device part, a flexible cable configured to electrically connect the first device part and the second device part, and for each component being an electro-active component, a connector suitable for providing an electrical connection between the electronic device and the at least one electro-active component;

providing closure means comprising a sealing element;

integrating the electronic device into the eyeglass frame, wherein the first device part is arranged at least partially in the first cavity, the second device part is arranged at least partially in the second cavity, and the flexible cable is arranged in the groove, wherein the closure means are arranged to ensure that the electronic device is enclosed in such a way that it is substantially protected from moisture intrusion or other contamination.

The electro-optical component may be (preferably) an electro-active lens, or an LED, VCSELS or similar component.

The flexible cable is arranged in the groove, wherein the closure means are arranged to ensure that the electronic device is enclosed in such a way that it is substantially protected from moisture intrusion or other contamination.

In some embodiments the sealing element is at least partially made of a flexible material. In this manner the shape of the sealing element can be adapted to correspond (at least to some extent) to the shape of the groove inside which the flexible cable is arranged. This makes it easier to seal of the groove with the flexible cable inside so that the cable is protected from moist etc.

In some embodiments the sealing element is at least partially made of compressible material and/or elastic material. Elastic material is compressible but also has the tendency to return at least partially to its original shape once it has been compressed. For instance, the sealing element in this way can be easily attached to the front part of the eyeglass frame by clamping the sealing element into or onto the front part, for instance into the groove provided in the groove.

In embodiments of the present disclosure the first cavity of the first temple part is in connection with one end of the groove and the second cavity in the second temple part is in connection with the opposite end of the groove. The method then may comprise arranging the flexible cable in the first cavity, in the groove and in the second cavity in order to provide an electrical connection between the first (electronic) device (to be) installed in the first cavity and the second (electronic) device (to be) installed in the second cavity.

In embodiments of the present disclosure the method comprises the following steps. First, the method comprises providing an eyeglass frame, an electronic device, and closure means. The eyeglass frames comprise a front part, a first temple and a second temple. Said temples each comprise a front temple part, of which one end is attached to a side of the front part, and a rear temple part. The other ends of the front temple parts are attached to the respective rear temple parts in such as way that the front temple parts and rear temple parts are movable with respect to each other, which allows the glasses to be foldable. The first front temple part is provided with a first cavity and the second front temple part is provided with a second cavity and the front part is provided with a groove running from the first cavity to the second cavity, preferably on the rear side. These cavities and this groove allow the frames to accommodate the electronics. The electronic device comprises a first device part, a second device part, and a flexible cable configured to provide an electrical connection between the first device part and the second device part. The closure means comprise a sealing element wherein the sealing element is preferably at least partially made of a flexible, compressible and/or elastic material. The method further comprises integrating the electronic device into the eyeglass frame, wherein the first device part is arranged at least partially in the first cavity, the second device part is arranged at least partially in the second cavity, and the flexible cable is arranged in the groove, wherein the closure means are arranged to ensure that the electronic device is enclosed in such a way that it is substantially protected from moisture intrusion or other contamination. In particular, it is desirable to protect the electronic device from any element which may impede its functioning or reduce its lifetime.

Note that in this description, the “front” side is the side with the front part, i.e. the side which, when the eyeglasses are worn by a user, is oriented forward; correspondingly, the “rear” side is opposite to that, such that the rear side of the front part is the side which, when the eyeglasses are worn by a user, is oriented towards the user's face. Note furthermore that potential other elements of the frame which are not of particular relevant to the disclosure, such as for instance nosepads, may also be included in the eyeglass frame.

The sealing element may comprise any suitable material to achieve a seal which allows for the protection from moisture intrusion or other contamination. Flexible materials may be suitable, for instance. A compressible material may be advantageous, and an elastic material may in particular be useful—however, other possibilities also exist, depending also on the choice of material or materials for the frame. The word “elastic” is not intended herein as restrictive: for the purposes of the application, any material which is at least somewhat compressible, and which, when the compressing forces are no longer present, returns at least in part—though not necessarily completely—to its initial shape and size, is an elastic material. Possible elastic materials include rubbers and certain silicones, such as elastomers. Note furthermore that to be able to achieve the desired protection from moisture intrusion or other contamination, the sealing element advantageously comprises a moisture-resistant or preferably water-impervious material.

Preferably, in the eyeglass frame, the first front temple part and the second front temple part, which are the parts which include the cavities, are fixedly connected on either side of the front part. In other words: these parts cannot move with respect to the front part. This means that the section of the eyeglass frame into which the electronics are integrated does not need to include hinges or other moving parts, and that in integrating the electronic device no specific (and often complex) arrangements need to be made to provide an electronic connection through a hinge. It is even possible to provide the front part, the first front temple part and the second front temple part as a single element, for instance manufacturing it by injection molding, milling (including CNC milling), or 3D printing; however it is also possible to provide the section of the frame comprising the front part and the front temple parts by providing a plurality of elements, potentially including different materials, and fixedly connecting them, for instance by gluing, heating and pressing, or welding—the method may depend on the used materials, for example. These elements may, but need not, each correspond to one of the front part, the first front temple part and the second front temple part. Manufacturing the front part and the front temple parts as a single element may be more robust; using a plurality of elements may be preferable for instance with frames milled at least partially of acetate, for which it may be difficult and/or economical to manufacture larger elements, and/or if it is deemed desirable to use a different material for the front temple parts than for the front part.

The movable attaching of the front temple parts to the respective rear temple parts may be provided by hinged connections, as is quite common in the field of eyewear design, but the skilled person in this field will also be aware of alternate options, for instance those used for hingeless frames. Note that the temples may include other parts in addition to the rear and front temple parts.

An advantage of the proposed method is that the eyeglass frame may be provided by modifying an existing eyeglass frame design to include the groove, the first cavity, and the second cavity. For instance, for frames made at least in part of injection molded plastic, the (usually metal) mold may be adapted to include the groove and/or cavities. Acetate based frames are individually milled from acetate slabs and can thus easily be adapted to include the groove and cavities. For 3D printed materials, the original CAD-file may be adapted, and so on. The modifying of the existing eyeglass frame design may comprise adapting the shape and size of the front part and/or the front temple parts such that they can accommodate the groove and/or the cavities, respectively. In particular, many existing eyeglass frame designs have no or only a small and sometimes quite slim front temple part bending rearwards from the front part, and include a hinged or other movable connection quite close to the rear side of the front part. Therefore, in modifying existing designs, it may be necessary to add front temple parts of sufficient size to accommodate the cavities, with a corresponding adaptation of the rear temple parts; or to lengthen, broaden and/or heighten existing front temple parts to be able to accommodate the cavities, with a corresponding adaptation of the rear temple parts. Advantageously, such modifications result in a frame wherein any hinge or other element allowing for respective movement of the front and rear temple parts is located behind, i.e. more towards the rear, the integrated electronics, which may improve the robustness and lifespan of the electronics, and/or which may allow for simpler frame/glasses design.

The groove may, depending on the specifics of the electronic device and in particular the flexible cable, be quite small, and therefore quite a few existing frame fronts may be able to accommodate it without requiring further modification. For instance, the groove may have a depth of between 1 and 5 mm, preferably between 3 and 4 mm, and a height of between 0.7 and 1.5 mm, preferably between 0.9 and 1.2 mm; note furthermore that it may be advantageous for the height of the groove to vary along its depth, for instance to improve the seal and/or to be able to firmly lodge the sealing element in the grove, which could be done by providing the groove with a recessed section as will be explained in more detail with respect to the figures. In other existing designs it may be necessary to modify the front part to be able to accommodate the groove.

Regardless of whether the eyeglass frame is a new design or a modified version of an existing design, note that it is desirable to adapt the size and shape of the first cavity, the second cavity and the groove to the size and shape of the electronic device and the closure means. Advantageously, both the cavities and groove and the electronic device will be designed to be as small as possible, so as to reduce bulk in the resulting glasses; it may furthermore be advantageous to standardize the size of the cavities and groove, such that a same electronic device may be integrated into different frame designs.

The first front temple part and/or the second front temple part of the frame provided in the method may comprise fastening elements configured to cooperate with the electronic device and/or the closure means in the step of integrating the electronic device into the eyeglass frame, for instance by cooperating with corresponding fastening elements included in the electronic device and/or the closure means. The fastening elements may, as described in more detail with respect to the illustrated embodiments, comprise a threaded opening, with the electronic device and/or the closure means then having an aperture such that they may be fastened to the temple parts by a correspondingly threaded screw. However, the skilled person will be aware of many possible fastening elements, including but not limited to fastening elements involving a screw or other threaded connection, snap/click fastening elements, clipping means, and adhesive.

Note that the providing of the frame may, but does not necessarily involve, the manufacturing of the eyeglass frame, for instance the manufacturing of at least parts of the frame by injection molding, milling, and/or 3D printing. It may also include the providing of all parts of the eyeglass frame and the assembling of these parts into an eyeglass frame; or the providing of some parts of the eyeglass frame and the manufacturing of other parts of the eyeglass frame.

Advantageously, the method outlined above may also be used in integrating an electronic device suitable for the control of at least one electro-active lens into an eyeglass frame. The method then includes fitted lenses in eyepieces included in the front of the eyeglass frame, wherein at least one of the lenses comprises an electro-active lens system. Such lenses may for instance be lenses for active 3D glasses, or electro-optical glasses with adjustable focus. To control such lenses, they must have an electrical connection to an electronic device. To accommodate such a connection, the method therefore may include providing an eyeglass frame wherein, for each lens comprising an electro-active lens system, a passage is provided from the cavity of the first and the second cavity which is closest to this lens, to an edge of the lens—specifically, to at least one connection point provided on or via the edge of the lens. The integrating of the electronic device into the eyeglass frame using the closure means then includes, for each lens comprising an electro-active lens system, establishing an electrical connection between the electronic device and the at least one electro-active lens system through the passage.

For instance, the provided electronic device may include, for each electro-active lens system, a connector suitable for providing an electrical connection between the electronic device and the electro-active lens system, and the electrical connection may be established by arranging this connector through the passage such that it contacts the electro-active lens system; for instance, this connector may contact the aforementioned connection point, or may be inserted partway into the lens in order to establish a connection.

In the provided electronic device, one of the first device part and the second device part may comprise a power supply device, and the other of the first device part and the second device part may comprise a printed circuit board (PCB). However, other arrangements are also possible.

The closure means provided in the method may comprise at least one interface element, wherein the interface element is preferably an element configured to allow a user to input a command for the electronic device; to output information from the electronic device to a user; or to allow power transfer to the electronic device. In existing electronic glasses, such interface elements are often integrated in the frame. However, since the proposed method uses closure means in the integrating of the electronic device into the frame, it may be advantageous to incorporate such interface elements in these closure means, instead. In particular, this may make it possible to integrate slightly different (but similarly sized) electronic devices into a given eyeglass frame design, without needing to further modify or adapt this design, by adapting the closure means. This may also make it possible to adapt the integration to a user's preferences: for instance, a right-handed user may prefer to have input means located on the right side of electronic glasses, while a left-handed user may prefer to have input means located on the left side of electronic glasses; the method according to the disclosure may, by providing appropriate closure means (together with a suitable electronic device), be used with a same eyeglass frame design to suit either type of user.

As mentioned previously, the electronic device should be sufficiently protected from moisture intrusion or other contamination. To this end, the sealing element of the closure means provided in the method may comprise a compressible and/or elastic front section configured to fit into and/or over the groove such as to define, with the groove, a channel configured to be able to accommodate the flexible cable of the electronic device.

Providing the closure means may further comprise providing a first lid and a second lid, wherein the first lid is configured as a cover for the first cavity in the first temple and the second lid is configured as a cover for the second cavity in the second temple; and providing sealing material between each of the said lid and said corresponding front temple parts to render the cavity protected from moisture intrusion or other contamination, said sealing material being optionally part of or attached to the sealing element covering the groove.

The sealing material may for instance be embodied as a first compressible and/or elastic ring and a second compressible and/or elastic ring which first ring is configured to provide a seal between the first lid and the first cavity, and which second ring is configured to provide a seal between the second lid and the second cavity. The integration step of the method preferably then comprises the following steps. For the electronic device: arranging the first device part at least partly in the first cavity, arranging the second device part at least partly in the second cavity, and arranging the flexible cable into the groove. For the sealing element of the closure means: arranging it such that the compressible and/or elastic front section seals the flexible cable into the groove, thus substantially protecting the flexible cable from moisture intrusion; the first ring is arranged around an edge of the first cavity; and the second ring is arranged around an edge of the second cavity. Finally, for the lids: arranging and fastening the first lid on the first cavity such that the first ring provides a seal between the first lid and the first cavity, thus substantially enclosing the first device part and protecting it from moisture intrusion; arranging and fastening the second lid on the second cavity such that the second ring provides a seal between the second lid and the second cavity, thus substantially enclosing the second device part and protecting it from moisture intrusion. For instance, as will be described in more detail with respect to a specific embodiment, a screw can be used to fasten each lid in a corresponding threaded opening in the respective cavity, tightly pressing the ring between the lid and an edge of the respective cavity, wherein this screw preferably also passes through a hole provided in the respective device part; however, other attachment means are also possible, for instance a snap-fit connection or even a moisture resistant adhesive. However, note that non-permanent connection methods are preferred, due to the desirability of accessing and potentially repairing and/or replacing the electronic device without needing to replace the eyeglasses as a whole.

It may also be desirable to assemble the electronic device and the closure means prior to the integration in the eyeglass frame. In such cases, the method comprises a step of assembling at least part of the closure means and the electronic device to form a sub-assembly, wherein preferably the electronic device is substantially protected from moisture intrusion or other contamination in the sub-assembly; followed by a step of fastening the sub-assembly to the eyeglass frames. This may be achieved for instance by the closure means comprising a first housing and a second housing, with the assembling the sub-assembly then comprising arranging the first housing around the first device part, such as to substantially enclose the first device part; and arranging the second housing around the second device part, such as to substantially enclose the second device part. Additionally or alternately, the method may then also includes encapsulating the flexible cable with a compressible and/or elastic material. This may be performed before, after, or simultaneously to the arranging of the first and second housings around the respective device parts. By doing this, it is not necessary to first arrange the flexible cable in the groove and to then seal the groove with a separately provided sealing element: instead, it is sufficient to arrange the encapsulated cable into the groove. Note that the compressible and preferably elastic material encapsulating the cable may in this case be seen as the sealing element of the closure means.

The flexible cable of the electronic device may be a simple cable, but it may also comprise a flexible PCB. For instance, the flexible cable may be a flexible printed circuit (FPC) cable. This may make it possible to minimize the size of the first and second device parts. Since such a flexible PCB may be more vulnerable than a simple cable, it is recommended to encapsulate it with a compressible and preferably elastic material, as described above, prior to arranging it in the groove.

The disclosure also relates to a method of manufacturing an electronic pre-assembly for use in the method described previously. This method comprises providing an electronic device comprising a first device part, a second device part, and a flexible cable, preferably a flexible printed circuit board (PCB), configured to provide an electrical connection between the first device part and the second device part; manufacturing a first housing and a second housing, wherein the first housing is shaped to fit at least partially in the first cavity and configured to enclose the first device part; and wherein the second housing is shaped to fit at least partially in the second cavity and configured to enclose the second device part; arranging and sealing the first housing to enclose the first device part; and arranging and sealing the second housing to enclose the second device part.

Preferably, the method also comprises encapsulating the flexible cable by a compressible and/or elastic material such that the electronic device as a whole is substantially protected from moisture intrusion or other contamination.

The method may also be used to manufacture an electronic pre-assembly for integration into an eyeglass frame fitted with at least one electro-active lens system. It then comprises providing at least one connector suitable for providing an electrical connection between the electronic device and an electro-active lens system.

The disclosure also relates to a method of manufacturing an eyeglasses frame for use in the previously described integration method, for instance with an electronic pre-assembly described above. The method comprises manufacturing a first front temple part with a first cavity; manufacturing a second front temple part with a second cavity; and manufacturing a front part with a groove, preferably on the rear side, wherein when the first front temple part and second front temple part are arranged on either side of the front part, the groove runs from the first cavity to the second cavity. The method further comprises manufacturing a first real temple part and a second rear temple part, configured to be attached to the first front temple part and second front temple part, respectively, in such a way that the front temple parts and rear temple parts are movable with respect to each other, preferably by a hinged connection. The first front temple part, the second front temple part, and the front part may be manufactured as a single piece, preferably by injection molding, milling, or 3D printing. Alternately, the section of the frame comprising the first front temple part, the second front temple part, and the front part may be manufactured by fixedly connecting separately manufactured elements to each other, wherein these elements may or may not correspond to the front and the front temple parts. Preferably, the size and shape of the first cavity, the second cavity and the groove are adapted to the size and shape of the elements to be integrated therein.

In another aspect, the disclosure relates to electronic glasses. “Electronic glasses”, as used in this application, includes any glasses wherein electronics are integrated into an eyeglasses frame. The electronic glasses may be configured to be provided with at least one electro-optical component, the electronic glasses comprising:

an eyeglass frame comprising
a front part, a first temple and a second temple;
wherein said temples each comprise a front temple part, of which one end is attached to a side of the front part, and a rear temple part,
wherein the other ends of the front temple parts are attached to the respective rear temple parts in such as way that the front temple parts and rear temple parts are movable with respect to each other;

an electronic device comprising a first device part, a second device part, a flexible cable configured to provide an electrical connection between the first device part and the second device part and, for each lens being an electro-optical component, a connector suitable for providing an electrical connection between the electronic device and the at least one electro-optical component;

closure means, comprising a sealing element;

wherein
the first front temple part comprises a first cavity, and the first device part is arranged at least partially in the first cavity,
the second front temple part comprises a second cavity, and the second device part is arranged at least partially in the second cavity, and wherein
the front part of the frame comprises a groove extending between the first cavity of the first temple part and the second cavity of the second temple part, and the flexible cable is arranged in the groove;
the closure means, including the sealing element, are arranged to ensure that the electronic device is enclosed in such a way that it is substantially protected from moisture intrusion or other contamination.

The front temple parts and rear temple parts are movable with respect to each other so that the glasses may be folded and take up less space when stored.

In embodiments of the present disclosure the sealing element is at least partially made of a flexible material. In further embodiments the sealing element is at least partially made of compressible material and/or elastic material.

In embodiments of the present disclosure the sealing element the flexible cable is configured to be accommodated into the groove and wherein the sealing element is attached on the front part so to seal the flexible cable inside the groove. In some embodiment the flexible cable is configured to be arranged in the first cavity, the groove and the second cavity in order to provide an electrical connection between the first and second device. of the electronic device.

Preferably, the first front temple part and the second front temple part are fixedly attached on either side of the front. The front part, the first front temple part and the second front temple part may be embodied as a single element, preferably manufactured by injection molding, milling, or 3D printing; alternately, the section of the frame comprising the front part, the first front temple part and the second front temple part may include a plurality of elements fixedly connected to each other, preferably by welding, gluing, or heating and pressing, which elements may, but need not, correspond to the front part and the front temple parts.

The connections between the front temple parts and the respective rear temple parts may be hinged connections.

In advantageous embodiments, the glasses further comprise lenses fitted in eyepieces included in the front part of the eyeglass frame, wherein at least one of the lenses comprises an electro-active lens system. The frame then comprises, for each eyepiece fitted with a lens comprising an electro-active lens system, a passage from the cavity of the first and the second cavity closest to this lens, to the edge of this lens. The electronic device is electrically connected to the electro-active lens system through this passage. For instance, this may be achieved by the electronic device comprising, for each electro-active lens system, a connector arranged through the passage to electrically connect the electronic device and the electro-active lens system.

In embodiments, one of the first device part and the second device part comprises a power supply device, and wherein the other of the first device part and the second device part comprises a printed circuit board (PCB), preferably a flexible printed circuit (FPC).

In embodiments, the closure means comprise at least one interface element, wherein the interface element is preferably an element configured to allow a user to input a command for the electronic device; to output information from the electronic device to a user; or to allow power transfer to the electronic device. Interface elements for input may for instance include buttons or other input means which allow a user to control the electronic device; interface elements for output may include visual output means, such as a window through which a user can see a led on the electronic device or an LCD screen, but are not limited thereto and could also for instance include audio output means; interface elements for power transfer may include charging contacts to enable charging of a power supply included in the electronic device without needing to remove the electronic device from the eyeglass frame or needing to remove or open the closure means.

The sealing element may comprise a compressible and/or elastic front section, arranged in and/or over the groove, thereby providing a sealed channel for the flexible cable.

In embodiments, the closure means may comprise a first lid and a second lid, wherein the first lid is arranged to cover the first cavity and to enclose the first device part between the first lid and the first cavity, and wherein the second lid is arranged to cover the second cavity and to enclose the second device part between the second lid and the second cavity, and sealing material may be provided between each of the said lid and said corresponding front temple parts to render the cavity protected from moisture intrusion or other contamination, said sealing material being optionally part of or attached to the sealing element covering the groove. The sealing material may be embodied as a first compressible and/or elastic ring and a second compressible and/or elastic ring, wherein the first ring is arranged between the first lid and the first cavity to provide a moisture resistant seal, and the second ring is arranged between the second lid and the second cavity to provide a moisture resistant seal.

In embodiments including both the elastic and/or compressible front section and the first and second rings, these are preferably manufactured as a single part, for instance out of a rubber or silicone/elastomer material. This may improve the sealing properties, and thus improve the protection of the electronic device from moisture intrusion.

In other embodiments, the closure means and the electronic device form a sub-assembly, wherein preferably the electronic device is substantially protected from moisture intrusion or other contamination in the sub-assembly. This sub-assembly is fastened to the eyeglass frame as a whole, preferably in a removable manner This may be achieved for instance by the closure means comprising a first housing and a second housing, wherein the first housing is arranged to enclose the first device part and is fastened at least partially in the first cavity, preferably using a snap-fit connection, and wherein the second housing is arranged to enclose second device part and is fastened in second cavity, preferably using a snap-fit connection. This makes it possible to pre-assemble the electronic device and closure means in such a way that the electronic device may be protected from moisture intrusion even prior to its being integrated into the eyeglass frame. The sealing element is then preferably configured to encapsulate the flexible cable, such that the combination of the first housing, the second housing and the sealing element substantially protects the electronic device from moisture intrusion or other contamination. If a snap-fit connection is desired, this may require the cavities and the housings comprising complementary fastening means allowing them to establish a snap-fit connection.

Advantageously, the flexible cable may comprise a flexible PCB.

The closure means may be fastened to the frame using screws, a moisture resistant adhesive, and/or any other appropriate fastener.

The frame may comprise at least one of plastic, preferably injection-molded plastic; acetate; and a 3D-printable material.

The disclosure also relates to an electronic pre-assembly for integration into an eyeglass frame provided with a first cavity in a front temple part of the first temple, a second cavity in a front temple part of the second temple, and a groove on the rear side of the front part, preferably for use in the previously described method and/or resulting in electronic glasses as described above. The electronic pre-assembly comprises an electronic device comprising a first device part, a second device part, and a flexible cable, preferably a printed circuit board (PCB) or a flexible printed circuit (FPC) cable, configured to provide an electrical connection between the first device part and the second device part; a first housing arranged to enclose the first device part and configured to be fastened at least partially in the first cavity; and a second housing, arranged to enclose the second device part and configured to be fastened at least partially in the second cavity.

Using this pre-assembly, makers of glasses then only need to manufacture a suitable eyeglass frame—which may be designed for this purpose with appropriately sized and shaped cavities and an appropriately sized and shaped groove, or which may be adapted from an existing design to include these cavities and this groove—to be able to produce electronic glasses as described above, by fastening the pre-assembly thereto.

The flexible cable may be encapsulated by a compressible and/or elastic material, such that the electronic device in the pre-assembly is already protected against moisture intrusion. At least one of the first housing and the second housing may comprise at least one interface element, wherein the interface element is preferably an element configured to allow a user to input a command for the electronic device; to output information from the electronic device to a user; or to allow power transfer to the electronic device.

In embodiments, the electronic device further comprises at least one connector suitable for providing an electrical connection between the electronic device and an electro-active lens system in a lens fitted into the eyeglass frame. Such a pre-assembly is then suitable for use with a frame fitted with at least one electro-active lens system.

The disclosure also relates to a kit for use in the previously described method, preferably resulting in electronic glasses as described above. Such a kit comprises an electronic device comprising a first device part, a second device part, and a flexible cable, preferably a flexible printed circuit board (PCB), configured to provide an electrical connection between the first device part and the second device part; and closure means comprising a first lid configured as a cover for the first cavity, a second lid configured as a cover for the second cavity, and a sealing element, wherein the sealing element is preferably at least partially made of a flexible, compressible and/or elastic material, and more preferably comprises a compressible and/or elastic front section configured to fit in and/or over the groove to form an enclosed channel. Like the pre-assembly, such a kit makes it possible for makers of glasses to produce electronic glasses by manufacturing a suitable eyeglass frame and then integrating the electronic device into it using the closure means.

To ensure that the electronic device is protected from moisture intrusion, the sealing element may further comprise a first compressible and/or elastic ring and a second compressible and/or elastic ring, wherein the first ring is configured to be arranged between the first lid and the first cavity to provide a moisture resistant seal, and the second ring is configured to arranged between the second lid and the second cavity to provide a moisture resistant seal, wherein the sealing element is preferably manufactured as a single part, preferably out of a rubber or silicone material.

Preferably, at least one of the first lid and the second lid comprises at least one interface element, wherein the interface element is preferably an element configured to allow a user to input a command for the electronic device; to output information from the electronic device to a user; or to allow power transfer to the electronic device.

In some embodiments, the electronic device further comprises at least one connector suitable for providing an electrical connection between the electronic device and an electro-active lens system in a lens fitted into the eyeglass frame.

The kit may further comprise fastening means configured to fasten the first lid on the first cavity and the second lid on the second cavity, the fastening means preferably further configured to fasten the first device part in the enclosure formed by the first cavity and the first lid and to fasten the second device part in the enclosure formed by the second cavity and the second lid.

Note that with any aspect of the disclosure described above, it may be advantageous to standardize the shapes and sizes of the cavities and groove, of the electronic device, and/or of the closure means, such that elements may be interchanged between different embodiments. This could allow a consumer to assemble electronic glasses as desired. For instance, if there is a range of frames provided with the same of similarly configured cavities and groove, a user may choose a frame based on aesthetic preferences, or transfer an electronic device to a different frame. If different electronic devices are configured to have a similar shape and size, the user may then select an electronic device based on a desired function; or could even for some embodiments use the same frame for different purposes, by switching the electronic device. Closure means could be provided in different colors, for instance to suit different frames, and/or may include suitable input means, output means and/or charging means adapted to a given electronic device and/or to a user's preferences.

It may additionally be advantageous to configure the cavities in such a way that the electronic device and the closure means may be arranged in two different ways, i.e. either with the first device part arranged to the first cavity and the second device part to the second cavity or vice versa.

Advantages of the described aspects include that electronics of many different types may be integrated in frames with a variety of designs in a relatively simple way, while minimizing the added bulk and providing protection against moisture intrusion.

### BRIEF DESCRIPTION OF THE DRAWINGS

The disclosure will be further illustrated at the hand of the appended figures, wherein:

FIG. 1 shows an embodiment of the glasses according to an exemplifying embodiment, in a disassembled state;

FIG. 2 shows the embodiment of FIG. 1 in its assembled state;

FIG. 3 shows a top view of the disassembled embodiment shown in FIG. 1;

FIG. 4A and FIG. 4B are detail views from different perspectives of the disassembled embodiment of FIGS. 1 and 3.

FIG. 5 is a perspective view of another embodiment of the electronic glasses according to the present disclosure, in a disassembled state;

FIG. 6A shows the embodiment of FIG. 5 in its assembled state;

FIG. 6B shows a cross-cut detail of FIG. 6A along the line A-A indicated in that figure;

FIGS. 7A and 7B show a further embodiment of the glasses according to the present disclosure, while FIG. 8 is a detail back side view of a part of the groove that is configured to be widened.

### DETAILED DESCRIPTION OF ILLUSTRATED EMBODIMENTS

Note that like reference numerals are used for like parts in the following description. A list of all used numerals and a brief description thereof can be found at the end of this description.

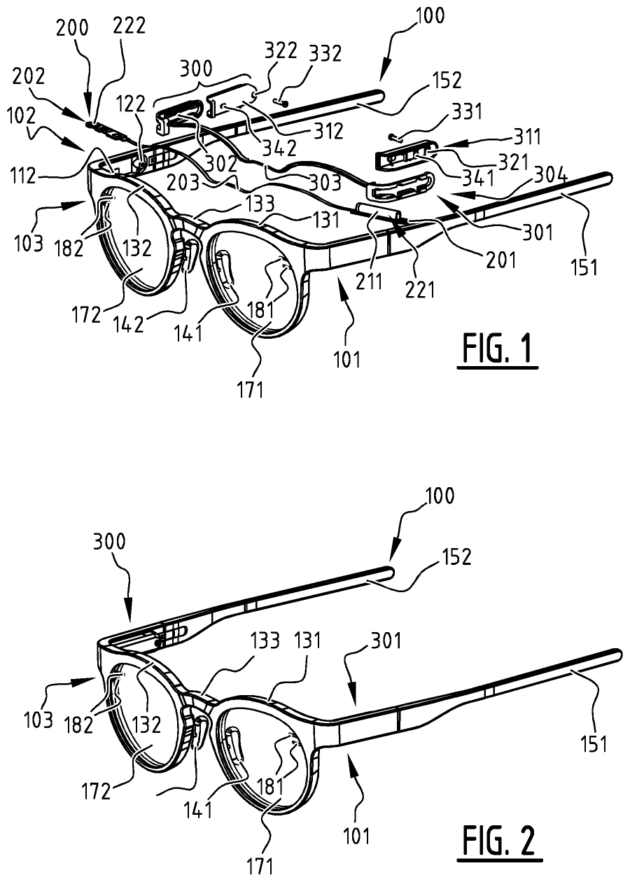

FIGS. 1, 2, 3, 4A and 4B illustrate one possible embodiment of electronic glasses according to examples of the present disclosure.

FIG. 1 shows an exploded view in perspective, to be able to illustrate the various elements of the glasses. An eyeglass frame 100 comprises a front part 103, with on the left side a left front temple part 101 and a left rear temple part 151 and on the right side a right front temple part 102 and a right rear temple part 152. In FIG. 1, hinge 162 is visible, connecting right front temple part 102 and right rear temple part 152 so that the rear temple part can be folded inwards, towards the front part; left front temple part 101 and left read temple part 151 are similarly connected by a hinge (not visible in the figure). Other types of connections which allow the rear temple parts to be folded inwards are known to the skilled person in the field of (normal) eyeglass design.

A first or left cavity 111 (not visible) is provided in left front temple part 101; a second or right cavity 112, of which the shape may mirror the shape of the first/left cavity but which may also have a different shape, is provided in right front temple part 102. The size, shape and dimensions may differ from what is depicted, and will be adapted to the size, shape and dimensions of the electronic device 200 and the closure means 300. The cavities may for instance be more shallow than depicted here, as it is not required for electronic device 200 and closure means 300 to be fully taken up in the space that would, absent a cavity, be occupied by the front temple part. It is sufficient that the cavity can receive electronic device 200 and closure means 300 at least in part, and can serve as an anchoring point therefore. In the depicted embodiment, second/right cavity 112 includes a threaded opening 122, suitable for a screw to be screwed into it, but many alternative or additional fastening means are also possible. Correspondingly, the first/left cavity, which is not visible in FIG. 1, comprises a second threaded opening.

The front part 103 comprises a left eyepiece 131 with a left lens 171; a right eyepiece 132 with a right lens 172; and a bridge 133 connecting eyepieces 131, 132, and further is provided with a left nosepad 141 and a right nosepad 142 for comfortable support of the glasses on user's nose.

As is well-known to the aforementioned skilled person in the field of eyeglass design, various other forms of frames 100 are possible, for instance with differently shaped eyepieces, a different type of bride, or wherein the nosepads are embodied as ridges on the internal side of the eyepieces. For the present disclosure, any eyeglass frame 100 in which there is sufficient space in the front part 103 to provide a suitable groove and sufficient space in the front temple parts 101, 102 to provide suitable cavities 111, 112 may be used.

Electronic device 200 is depicted in FIG. 1 in an extended state: during the step of integrating the electronic device into the frame, flexible cable 203 will be bent so that first device part 201 may be arranged in first/left cavity 111 and so that second device part 202 may be arranged in second/right cavity 112. In the shown embodiment, first device part 201 consists mainly of a battery 211, preferably a rechargeable battery, on and connected to an electronic substrate, and second device part 202 includes a controller, for instance comprising a printed circuit board (PCB), but many other arrangements are possible, depending on the intended purpose of the electronic glasses. In the shown embodiment, first device part 201 and second device part 202 further comprise a first aperture 221 and second aperture 222, which can be aligned with the first threaded opening in the first cavity and second threaded opening 122 in second cavity 112, respectively, thereby making it possible to fix first device part 201 and second device part 202 in the respective first and second cavity by a screw; however, many alternative ways of securing the first device part and second device part are also possible.

While this is not shown in the figures relating to this particular embodiment, if the electronic device is a device for control of at least one electro-active lens system, it may further comprise at least one suitable connector for connecting the electronic device to the at least one electro-active lens system.

In the depicted embodiment, closure means 300 include a number of elements, which may be separately provided. In particular, closure means 300 include a sealing element 304 formed of a first/left ring 301, a second/right ring 302, and a front section 303. Closure means 300 further include first/left lid 311, which is provided with first lid opening 321 suitable for first screw 331, and second/right lid 312, which is provided with second lid opening 322 suitable for second screw 332.

The lids further include elements which make it possible to interact with electronic device 200 in various ways. In this particular embodiment, first lid 311, which is intended to cover the first cavity in first front temple part 101 to enclose first device part 201 including its battery 211, includes charging contacts 341, to make it possible to charge battery 211 without needing to remove first lid 311. Second lid 312, meanwhile, is provided with an interface element in the form of output means, specifically in this embodiment a window 342 which may allow light from an LED (not shown) on the PCB to be visible through the lid, thus functioning as a led indicator.

It will be clear that in integrating electronic device 200 into eyeglass frame 100 using closure means 300, first lid 311 and second lid 312, including elements such as charging contacts 341 and window 342, should where needed be chosen to cooperate with the specific first device part 201 and second device part 202 of electronic device 200, e.g. such that a potential window is aligned with a potential led or such that charging contact, after assembly, contact a rechargeable power source so that it may be charged. Lids 311, 312 should furthermore be sized and shaped to function as covers for the first cavity and second cavity 112, respectively, wherein first and second device parts 201, 202, respectively, should fit in the enclosed space that is then created. Likewise, first ring 301 and second ring 302 should be configured such that they may form a moisture resistant seal between lids 311, 312 and an edge of the respective cavity.

Electronic device 200 may be integrated into eyeglass frame 100 by bending flexible cable 203 and arranging first device part 201 in the first cavity and second device part 202 in second cavity 112, such that the threaded openings in the cavities align with the apertures in the device parts. Flexible cable 203 is placed in a groove (not shown in FIG. 1) on the rear side of the front part, preferably such that no part of flexible cable extends from the groove, more preferably not occupying the entire depth of the groove, such that a shallower groove remains present after the flexible cable is placed.

Sealing element 304 is then arranged with first ring 301 around an edge of the first cavity, second ring 302 arranged around an edge of second cavity 112, and the front section 303 being fitted into the groove, closing it off—preferably, in the resulting glasses the groove is completely closed, and the surface of front section 303 is flush with the surface of the rear side of front part 103.

First ring 301 and second ring 302 are then fixed by placement of first lid 311 and second lid 312, respectively, and by the fastening thereof by means of screws 331, 332, wherein first screw 331 is inserted through first lid opening 321 and aperture 221 and screwed into the threaded opening in the first cavity, and second screw 332 is analogously inserted through second lid opening 322 and aperture 222 and screwed into second threaded opening 122 in second cavity 112.

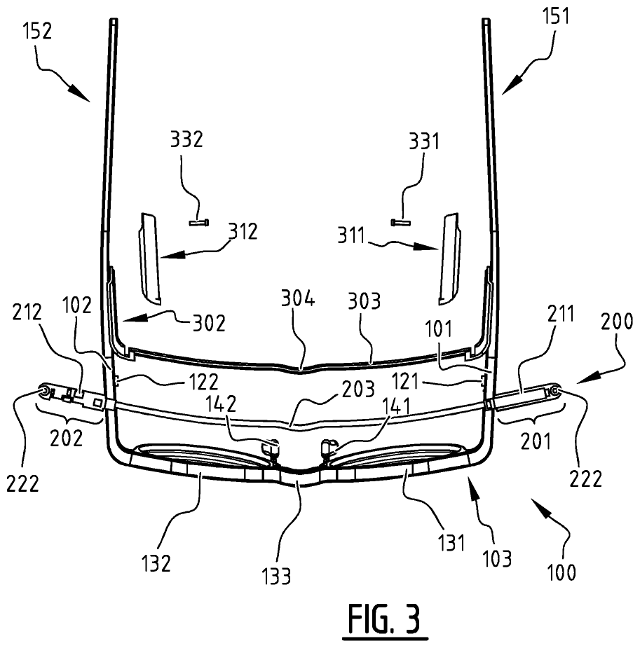

The resulting electronic glasses, in which the electronic device is well protected from moisture intrusion due to the seal provided by sealing element 304, is shown in FIG. 2.

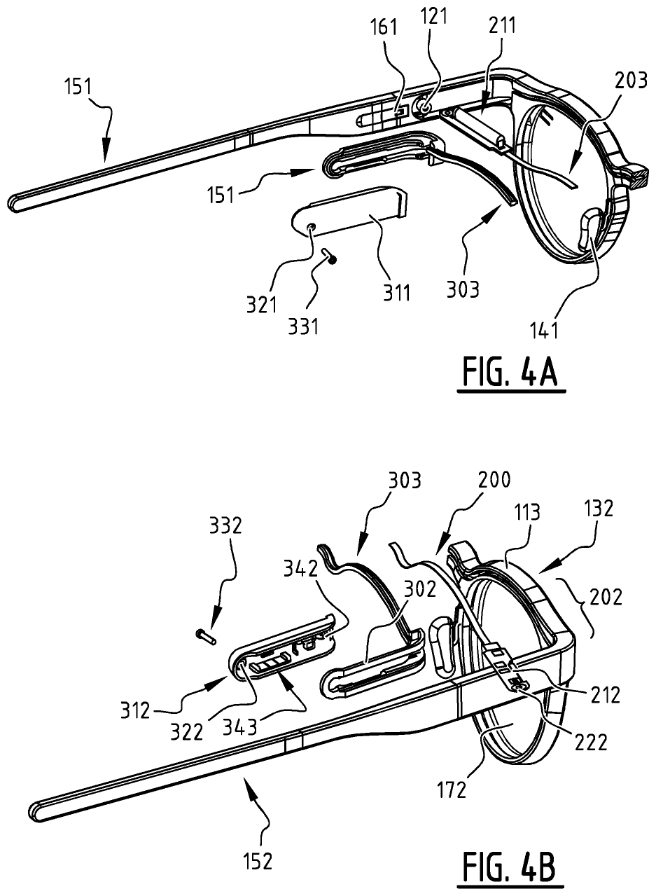

FIG. 3 shows a top view of a the disassembled glasses of FIGS. 1 and 2, showing frame 100 with front part 103, including eyepieces 131, 132, bridge 133, and nosepads 141 and 142; left front temple part 101 with first cavity 121 and left rear temple part 151; and right front temple part 122 with second cavity 122 and right rear temple part 152; showing electronic device 200 including first device part 201 with battery 211 and aperture 221, second device part 202 with controller 212, for instance a PCB, and aperture 222; and flexible cable 203 connecting the two, wherein this cable can be bent to arrange the electronic device in the frame; and closure means 300, including sealing element 304 consisting of first ring 301, second ring 302, and front section 303 connecting the two; lids 311, 312; and screws 331, 332.

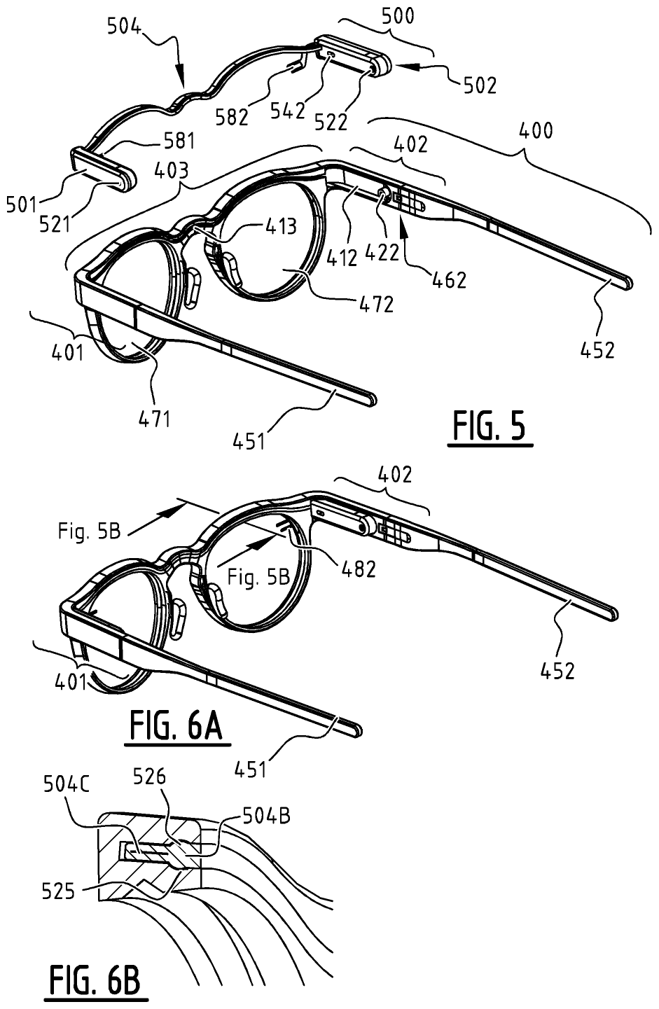

FIGS. 4A and 4B are more detailed view, each of half of the previously described embodiment. In particular, FIG. 4A shows first cavity 111 with first threaded opening 121, which cavity is connected to the groove for the flexible cable and to a passage leading to the edge of the first lens and the connection points therein. Note that once lid 311 is positioned as a cover to the cavity and attached with screw 331, with ring 151 or the sealing element arranged between lid 311 and an edge of the cavity, both device part 211 and the passage to the lens will be protected from moisture intrusion. FIG. 4B also shows groove 113, into which flexible cable 203 can be inserted, and which may then be sealed by the compressible and preferably elastic element 303 of sealing element 304. FIG. 4B shows how an input means such as a button may be integrated into the lid and allow a user to input commands to the electronic device.

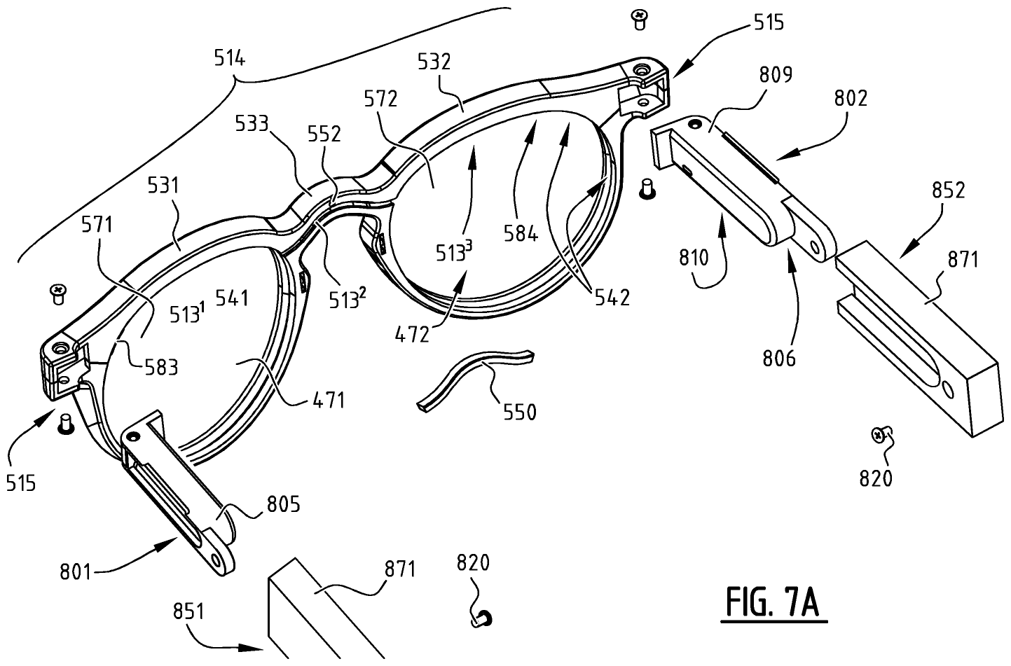

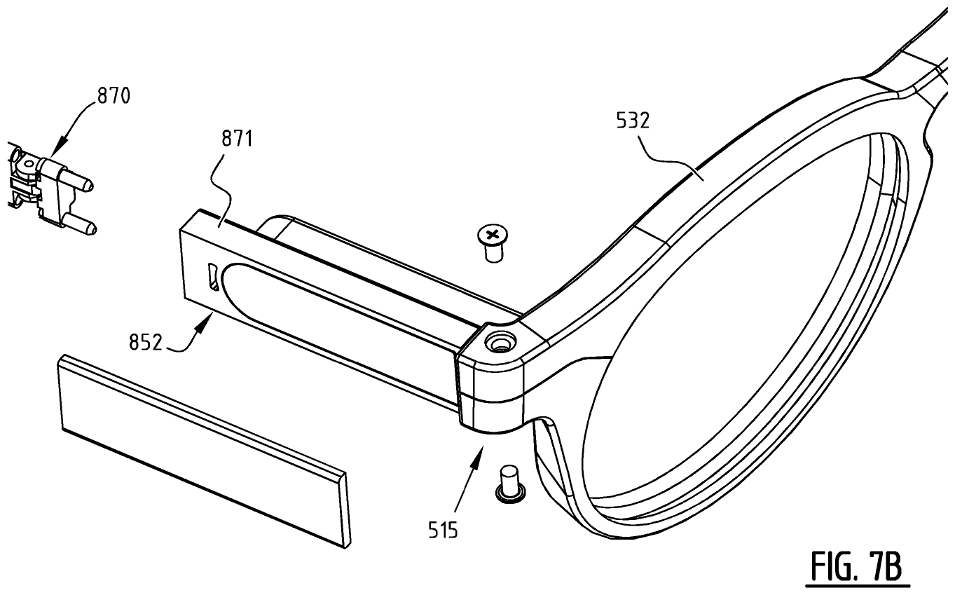

FIG. 5 and FIGS. 6A and 6B show a different embodiment of electronic glasses according to the disclosure. FIG. 5 shows the glasses in a state wherein a sub-assembly 500, comprising both the electronic device and the closure means, is not assembled with the eyeglass frame 400. In the shown assembly the sub-assembly forms an integrated sub-assembly of an electronic device and closure means (i.e. the closure means have been integrated with both electronic device parts of the electronic device). This has as an advantage that the sub-assembly, wherein the electronic device is well protected, for instance against moisture, may be provided to a manufacturer of eyeglass frames, and may be easily assembled later, potentially even by a user buying the eyeglass frame and the sub-assembly separately.

Sub-assembly 500 in the shown embodiment comprises first housing 501, enclosing a first electronic device part (not shown) including a battery, and second housing 502, enclosing a second electronic device part (not shown) including a controller, for instance comprising a PCB or similar arrangement. In the shown embodiment, the housings have apertures 521, 522 so that sub-assembly 500 can be fastened to eyeglass frame 400 by using screws, but it may be preferably to use another fastening method, for instance a snap-fit connection. Connectors 581 and 582, which are suitable to connect the electronic device to electro-active lens systems in lenses fitted in eyeglass frame 400, extend from the housings 501, 502. The sealing element of the closure means in integrated with the flexible cable in that the flexible cable is encapsulated by flexible and/or elastic material protecting the cable against external influences, like moist and the like. Encapsulated flexible cable 504 provides an electric connection between the first device part in first housing 501 and the second device part 502. Advantageously, the cable may comprise or even be embodied as a flexible PCB (FPC).

Eyeglass frame 400 is quite similar to the eyeglass frame described with respect to the embodiment of FIGS. 1-4: in fact, it may be that a same eyeglass frame is compatible with both a sub-assembly such as sub-assembly 500 and with an electronic device and separate closure means as described in conjunction with the embodiment described earlier.

Eyeglass frame 400 comprises front section 403, with lenses 471 and 472 fitted into the eyepieces, wherein these lenses may comprise an electro-active lens system (note that while connection points of these electro-active lens systems are not explicitly depicted here, this should not be seen as indicating their absence). Groove 413 is formed along the top edge of front part 403. Right front temple part 402 includes cavity 412, which is in this embodiment, for the screw connection, provided with threaded opening 422—left front temple part 401 is similarly formed. Passage 492 goes from cavity 412 to an edge of lens 472; a similar passage is provided from the (non-depicted) cavity in the left front temple part to left lens 471. Rear temple parts 451, 452 are attached to the front temple parts 401, 402 through hinged connection 462.

FIG. 6A shows this embodiment in its assembled state. Connector 582 is inserted through passage 492 to connect to connection points 482 in right lens 472. Housings 501, 502 are fastened to the front temple parts by a screw connection, though other connections are possible and may even be preferred.

FIG. 6B shows a cross-section along line A-A indicated in FIG. 6A, which shows that flexible PCB 504C is fully encapsulated by 504B, thus protecting it. It may further be seen that the encapsulated flexible PCB is fitted into the groove: in this embodiment, the groove may comprise recessed sections 525 towards its opening, and the encapsulation 504B of the PCB may comprise corresponding bulges 526: this may assure a more secure retention of the encapsulated PCB in the groove, while still allowing it to be removed from the groove if/when needed.

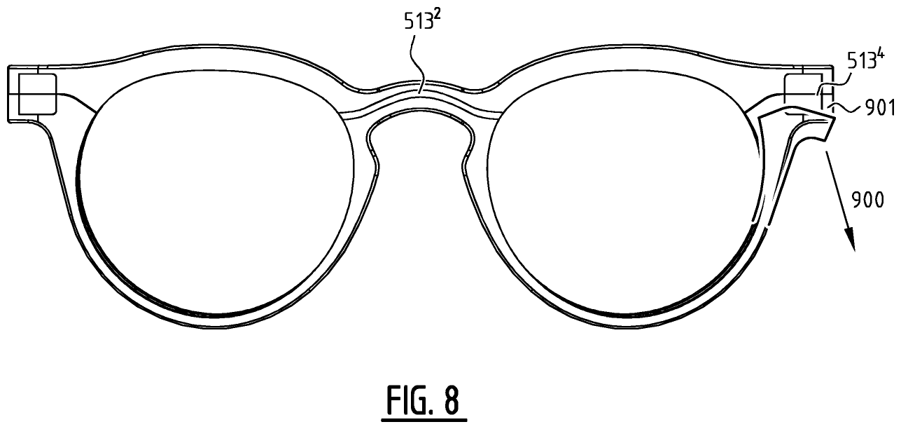

In the embodiments shown in FIGS. 1-6A the groove 113, 413 extends between the first cavity 111 of the first front temple part and the second cavity 112 of the second temple part over substantially the whole length of the front part 403, i.e. over the upper part of the left eyepiece 131, over the bridge 133 and over the upper part of the right eyepiece 132. Furthermore, the groove 113, 413 is provided in the inward face of the left eyepiece 131, bridge 133 and right eyepiece 132, i.e. the side facing the eyes of the user when the eyeglass frame is worn by the user. In the embodiment shown in FIGS. 7A, 7B the eyeglass frame similarly comprises a front part 514 comprising a left eyepiece 531 with a left lens 571, a right eyepiece 532 with a right lens 572, a bridge 533 connecting eyepieces 531, 532 (and may optionally a left nose pad and a right nose pad) and a groove 513 (comprised of groove parts 513¹, 513² and 513³ in open connection with each other) extending over substantially the whole length of the front part 514, i.e. over the upper part of the left eyepiece 531, over the bridge 533 and over the upper part of the right eyepiece 532, but in the bridge 533 the groove 513² is provided in the inward face 552 of the bridge 533 whereas in the left and right eyepiece 531, 532 the groove 513 is provided in the respective radially inwardly directed circumferential surfaces 541 and 542 (i.e. the surfaces facing the lenses 571 and 572). This has a number of advantages. First of all, the thickness (i.e. the height h) of the upper part of the left eyepiece 531 and the upper part of the right eyepiece 532 can be reduced. Secondly, by providing the groove 513 (i.e. the groove parts 513¹ and 513³) in the inwardly directed circumferential surfaces 541, 542 the groove parts 513¹ and 513³ may be sealed off from the environment by positioning the lenses 571, 572 on top of or slightly inside the groove thereby fully covering the groove parts. The (bridge) part 513² of the groove 513 present in the bridge 533 in this case may be sealed off from the environment (with the cable 503 arranged inside the groove 513) by placing a sealing element 550, preferably a sealing element comprised of a compressible and/or elastic material, on and/or or inside the groove part 513².

In the embodiment of FIG. 6A the electrical connectors comprise electrical wires 581, 582 arranged in a passage 492 providing an open connection with the cavity 412, the electrical wires forming electrical connections (only the outer ends being shown in the figure) with the connection points in the respective electro-active lenses 471, 472. As is (partially) shown in FIGS. 5 and 6A, the electrical wires 582 of the electrical connector of the right electro-active lens 472 may extend as separate wires from the electronic device (for instance, the controller) in the second housing 502 via the passage 492 towards the electrical connections of the right lens 472 and as separate wires from the same electronic device via the passage 492 and the groove 413 to the electrical connection points in the left lens 471. In other embodiments, for instance embodiments similar to those of FIGS. 7A and 7B, the electrical wires of the electrical connectors 581, 582 may have been integrated into the cable 504. In these embodiments the cable 504 comprises a plurality of electrical connections so as to be able not only to provide a supply voltage from the battery inside the first housing 501 to the controller in the opposite second housing 502, but also to provide control signals for controlling the left and right electro-active lenses 471, 472 from the controller in the second housing 502 to the respective connections points in the respective lenses 471, 472.

In mounted position the electrical wires 581,582 are connected to the connection points so as to provide electrical contact between the electrical connection point and the second device part 202 (for instance the controller 212 (PCB).

In the embodiment of FIGS. 7A and 7B, however, such passage can be dispensed with and the connector 583, 584 can be fully accommodated inside the respective groove part 513¹, 513³. Alternatively or additionally, if the connection points 482 are provided at the radially outwardly directed circumferential surfaces of the lens 471, 472, then the connector 583, 584 can be made to directly contact the connection points 482 (i.e. separate electrical wires can be dispensed with), for instance by placing the connector 583, 584 directly on top of the connection points 482 of the lens 471, 472. In these cases the connector 583, 584 may form an integral part of the cable 503, more specifically be an integral part of the flexible printed circuit (FPC) cable. The manufacturing of the eyewear can be simplified and/or the risk of defects in the electrical connections can be reduced even further.

In the embodiment of FIGS. 7A and 7B the eyeglass frame comprise a front part 514, a left front temple part 801, a right front temple part 802, a left rear temple part 851 and a left rear temple part 852. Each of the rear temple parts 851, 852 comprises a first rear temple part 871 and a second rear temple part 870. The first and second rear temple parts are shown here as separate parts, although in other embodiments the first and second rear temple parts 870, 871 are integrated.

The front temple parts 802, 803 may be fixedly connected to the associated front part 514 (through connection elements such as screws 515 arranged at an outer end of the front temple part). The other other ends of the front temple parts 802, 803 are attached to the respective rear temple parts 851, 852 in such as way that the front temple parts and rear temple parts are movable with respect to each other. Whereas the connections between the front temple parts and the respective rear temple parts of the embodiments of FIGS. 1-6A are hinged connections, the connections between the front temple parts 802, 803 and the respective rear temple parts 851, 852 of the embodiments of FIGS. 7A-7B are slidable connections: the rear temple parts 851, 852 may be slid over the upper outer surface 809 and lower outer surface 810 of the first housing 805 of the left front temple part 801 and the second housing 806 of the right front temple part 802 and then connected to each other using screws 820.

FIG. 8 is a detailed back side view of a part of the groove 513 shown in FIGS. 7A and 7B. The figure shows that a lower part 901 of both the left eyepiece 531 and the left eyepiece 532 are provided with a groove part 513⁴. Furthermore, the lower part 901 can be manually bent slightly downward (see arrow 900) so as to widen the groove part 513⁴. This makes it possible for a user to easily insert the flexible cable 504 into the groove 5134. The lower part 901 then bends back to its original position so that the flexible cable 504 then is maintained firmly inside the groove part 513⁴.

Note that while the figures only show the front temple parts attached to the front part, and while in embodiments the front part and the front temple parts may indeed be manufactured together, this is not a requirement. In fact, for certain choices of materials and/or certain frame designs, it may be preferably to manufacture the front part and the front temple parts separately, and to later assemble them. It may also be possible to have a first element including the front part and a subsection of the front temple parts, with the remainder of the front temple parts being manufactured separately and assembled later; likewise, it may be possible to include subsections of the front part in separately manufactured elements further comprising the front temple parts, etc.—in other words, the border between the front part and the front temple parts need not correspond exactly to the edges of separately manufactured parts.

As an example, in some embodiments, a first element may correspond to the front part, or include both the front part with the groove and a subsection of the front temple parts and the cavities therein. This first element may for instance advantageously be milled, for instance CNC milled, from an acetate slab. Second elements, which each include the remainder of a front temple part and a cavity, may then be made either also of milled acetate, or may be manufactured in a different way: for instance, they may be manufactured by injection molding a plastic material, by 3-D printing a suitable material, or even made of metal. These second elements are then attached to the first element in a way that is suitable for the material or materials used: for instance, through gluing or—if possible—welding. Third elements, corresponding to the rear temple, are then also manufactured separately, out of a suitable material which may or may not correspond to the material sued for the first element and second elements, and may for instance be attached to the second elements with hinges.

It is to be understood that this invention is not limited to the particular described embodiments, and, as such, may vary. It is also to be understood that the terminology used herein is for the purpose of describing particular aspects only, and is not intended to be limiting, since the scope of the present invention will be limited only by the appended claims.

1-50. (canceled)

51. Electronic glasses configured to be provided with at least one electro-optical component formed by an electro-active lens, the electronic glasses comprising:
an eyeglass frame comprising:
a first temple and a second temple, wherein the first and second temple comprise respectively a first front temple part and a second front temple part, wherein one end of each of the first front temple part and the second front temple part is attached to a side of the front part, wherein the first and second temple comprise respectively a first rear temple part and a second rear temple part, and wherein the first front temple part comprises a first cavity and the second front temple part comprises a second cavity; and
a front part comprising a left eyepiece for a left electro-active lens, a right eyepiece for a right electro-active lens, a bridge connecting the left and right eyepieces, and a groove extending over substantially the whole length of the front part between the first cavity of the first front temple part and a second cavity of a second front temple part,
wherein the other ends of the first and second front temple parts are attached to the respective rear temple parts in such a way that the front temple parts and rear temple parts are movable with respect to each other;
an electronic device comprising a first device part arranged at least partially in the first cavity, a second device part arranged at least partially in the second cavity, a flexible cable configured to provide an electrical connection between the first device part and the second device part, and at least one connector suitable for providing an electrical connection between the electronic device and the at least one electro-active lens;
a flexible cable arranged in the groove,
wherein the groove comprised of a first, second and third groove part, wherein the second groove part is arranged in an inward face of the bridge, and wherein the first groove part and third groove part are respectively arranged in the radially inwardly directed circumferential surfaces of the left eyepiece and the right eyepiece; and
closure means comprising a sealing element arranged in the second groove part to ensure that the electronic device is enclosed in such a way that it is substantially protected from moisture intrusion or other contamination.

52. The electronic glasses of claim 51, wherein if an electro-active lens comprises connection points provided at its radially outwardly directed circumferential surfaces, then the connector is arranged to directly contact the connection points, for instance by placement of the connector directly on top of the connection points of the associated electro-active lens.

53. The electronic glasses of claim 51, wherein the closure means comprise a first housing and a second housing, wherein the first housing is arranged to enclose the first device part and is fastened at least partially in the first cavity, preferably using a snap-fit connection, and wherein the second housing is arranged to enclose second device part and is fastened in second cavity, preferably using a snap-fit connection.

54. The electronic glasses of claim 53, further comprising electrical wires integrated into the flexible cable so as to provide a supply voltage from the first device part, for instance a battery, inside the first housing to the second device part, for instance a controller, in the opposite second housing and to provide control signals for controlling the left and right electro-active lenses from the second device part in the second housing to respective connections points in the respective electro-active lenses.

55. The electronic glasses of claim 51, wherein the sealing element is at least partially made of a flexible material and/or wherein the sealing element is at least partially made of compressible material and/or elastic material.

56. The electronic glasses of claim 51, wherein the flexible cable is configured to be arranged in the first cavity, the groove and the second cavity in order to provide an electrical connection between the first and second device parts of the electronic device.

57. The electronic glasses of claim 51, wherein the first front temple part and the second front temple part are fixedly attached on either side of the front part, and/or wherein the front part, the first front temple part and the second front temple part are embodied as a single element, preferably manufactured by injection molding, milling, or 3D printing, and/or wherein the section of the frame comprising the front part, the first front temple part and the second front temple part includes a plurality of elements fixedly connected to each other, preferably by welding, gluing, or heating and pressing and/or wherein the connections between the front temple parts and the respective rear temple parts are hinged connections.

58. The electronic glasses of claim 51, wherein the frame comprises, for each eyepiece fitted with a lens comprising an electro-optical component, a passage from the cavity of the first and the second cavity closest to this lens, to the edge of this lens, and wherein the electronic device is electrically connected to the electro-optical component(s) through the passage(s).

59. The electronic glasses of claim 51, further comprising at least one connector arranged through the passage(s) to electrically connect the electronic device and the electro-optical component(s).

60. The electronic glasses of claim 51, wherein the connector comprises connection wires arranged inside the passage, optionally also in the groove, and wherein the connection wires are configured to provide an electrical connection between the electronic device, preferably the device part comprising a controller for controlling the electro-optical component, and the electro-optical component.

61. The electronic glasses of claim 51, wherein the connection wires are wires separate from the flexible cable.

62. The electronic glasses of claim 51, wherein the connection wires are integrated with the flexible cable.

63. The electronic glasses of claim 51, wherein the first and second device parts, the flexible cable and the at least one connector are integrated in one module configured to be arranged as a whole in the eyeglass frame.

64. The electronic glasses of claim 51, further comprising:
a first device part comprising a battery for providing the at least one electro-optical component with electrical power;
a second device part comprising a controller for controlling the optical characteristics of at least one electro-optical lens;
a flexible cable connecting the battery with the controller; or
connections wires for connecting the controller with the at least one electro-optical component.

65. The electronic glasses of claim 51, wherein the closure means comprise at least one covering element comprising an interface element, and wherein the interface element is preferably an element configured to:
allow a user to input a command for the electronic device;
output information from the electronic device to a user; or
allow power transfer to the electronic device.

66. The electronic glasses of claim 51, wherein the sealing element comprises a compressible and/or elastic front section, arranged in and/or over the groove, thereby providing a sealed channel for the flexible cable.

67. The electronic glasses of claim 51, wherein the closure means comprise a first lid and a second lid, wherein the first lid is arranged to cover the first cavity and to enclose the first device part between the first lid and the first cavity, wherein the second lid is arranged to cover the second cavity and to enclose the second device part between the second lid and the second cavity, and wherein sealing material is provided between each of the said lid and said corresponding front temple parts to render the cavity protected from moisture intrusion or other contamination, said sealing material being optionally part of or attached to the sealing element covering the groove.

68. The electronic glasses of claim 51, wherein the sealing material is embodied as a first compressible and/or elastic ring and a second compressible and/or elastic ring, wherein the first ring is arranged between the first lid and the first cavity to provide a moisture resistant seal, and wherein the second ring is arranged between the second lid and the second cavity to provide a moisture resistant seal.

69. The electronic glasses of claim 51, wherein the compressible and/or elastic front section, the first ring, and the second ring are manufactured as a single part, preferably out of a rubber material or a silicone, preferably elastomer, material.

70. The electronic glasses of claim 51, wherein the closure means and the electronic device form a sub-assembly, and wherein preferably the electronic device is substantially protected from moisture intrusion or other contamination in the sub-assembly, which sub-assembly is fastened to the eyeglass frame, preferably in a removable manner.

71. The electronic glasses of claim 51, wherein the sealing element is configured to encapsulate the flexible cable, and/or wherein the flexible cable comprises a flexible printed circuit (FPC) cable.

72. The electronic glasses of claim 51, wherein the frame comprises:
plastic, preferably injection-molded plastic;
acetate; or
a 3D-printable material.

73. A method of integrating an electronic device into the electronic glasses of claim 51, the method comprising:
arranging the first device part at least partially in the first cavity and the second device part in the second cavity;
arranging the flexible cable in the groove; and
arranging the closure means into the second groove part to ensure that the electronic device is enclosed in such a way that it is substantially protected from moisture intrusion or other contamination.

74. The method of claim 73, comprising arranging the flexible cable into the groove and then attaching the sealing element onto the front part so to seal the flexible cable inside the groove.

75. The method of claim 74, comprising arranging the flexible cable in the first cavity, the groove, and the second cavity in order to provide an electrical connection between the first and second device of the electronic device.

76. The method of claim 73, wherein the providing of the eyeglass frame comprises providing an eyeglass frame wherein the first front temple part and the second front temple part are fixedly connected on either side of the front part.

77. The method of claim 76, wherein the providing of the eyeglass frame comprises providing the front part, the first front temple part, and the second front temple part as a single element, preferably wherein at least this single element is manufactured by injection molding, milling, or 3D printing.

78. The method of claim 73, wherein the section of the frame comprising the front part and the front temple parts is provided by providing a plurality of elements and fixedly connecting these elements to each other, preferably by gluing; heating and pressing; or welding.

79. The method of claim 73, wherein the movable attaching of the front temple parts to the respective rear temple parts is provided by hinged connections.

80. The method of claim 73, wherein the providing of the eyeglass frame comprises modifying an existing eyeglass frame design to include the groove, the first cavity, and the second cavity, and wherein the modifying of the existing eyeglass frame design preferably comprises adapting the shape and size of the front part and/or the front temple parts such that they can accommodate the groove and/or the cavities, respectively.

81. The method of claim 73, wherein the providing of the eyeglass frame comprises providing an eyeglass frame wherein the first front temple part and/or the second front temple part comprises fastening elements configured to cooperate with the electronic device and/or the closure means in the step of integrating the electronic device into the eyeglass frame.

82. The method of claim 81, wherein the fastening elements comprise a threaded opening, and wherein the electronic device and/or the closure means are provided with an aperture such that they may be fastened to the temple parts by a correspondingly threaded screw.

83. The method of claim 73, further comprising:
fitting lenses in eyepieces included in the front part of the eyeglass frame,
wherein at least one of the lenses is an electro-optical component,
wherein the providing of the eyeglass frame comprises providing an eyeglass frame,
wherein, for each lens comprising an electro-optical component, a passage is provided from the cavity of the first and the second cavity which is closest to this lens, to an edge of the lens, and
wherein the integrating of the electronic device into the eyeglass frame using the closure means includes, for each lens comprising an electro-optical component, establishing an electrical connection between the electronic device and the at least one electro-optical component system through the passage.

84. The method of claim 73, further comprising:
fitting lenses in eyepieces included in the front part of the eyeglass frame,
wherein at least one of the lenses is an electro-optical component, and
wherein the integrating of the electronic device into the eyeglass frame using the closure means includes, for each electro-optical component, establishing an electrical connection between the electronic device and the at least one electro-optical component through a flexible cable wherein at least one connector is integrated.

85. The method of claim 73, wherein the closure means further comprises a covering element comprising an interface element, and wherein the interface element is preferably an element configured to:
allow a user to input a command for the electronic device;
output information from the electronic device to a user; or
allow power transfer to the electronic device.

86. The method of claim 73, wherein the sealing element comprises a compressible and/or elastic front section configured to fit into and/or over the groove such as to define, with the groove, a channel configured to accommodate the flexible cable of the electronic device, and wherein the step of providing the closure means optionally comprises:
providing a first lid and a second lid, wherein the first lid is configured as a cover for the first cavity in the first temple and the second lid is configured as a cover for the second cavity in the second temple; and
providing sealing material between each of the said lid and said corresponding front temple parts to render the cavity protected from moisture intrusion or other contamination, said sealing material being optionally part of or attached to the sealing element covering the groove.

87. The method of claim 86, wherein the sealing material is embodied as a first compressible and/or elastic ring and a second compressible and/or elastic ring, which first ring is configured to provide a seal between the first lid and the first cavity, and which second ring is configured to provide a seal between the second lid and the second cavity.

88. The method of claim 87, wherein integrating the electronic device into the eyeglass frame using the closure means comprises the following steps:
arranging the first device part at least partly in the first cavity;
arranging the second device part at least partly in the second cavity;
arranging the flexible cable into the groove;
arranging the sealing element of the closure means such that:
the compressible and/or elastic front section seals the flexible cable into the groove, thus substantially protecting the flexible cable from moisture intrusion;
the first ring is arranged around an edge of the first cavity; and
the second ring is arranged around an edge of the second cavity;
arranging and fastening the first lid on the first cavity such that the first ring provides a seal between the first lid and the first cavity, thus substantially enclosing the first device part and protecting it from moisture intrusion; and
arranging and fastening the second lid on the second cavity such that the second ring provides a seal between the second lid and the second cavity, thus substantially enclosing the second device part and protecting it from moisture intrusion.

89. The method of claim 73, wherein the integrating of the electronic device into the eyeglass frame using the closure means comprises:
assembling at least part of the closure means and the electronic device to form a sub-assembly, wherein preferably the electronic device is substantially protected from moisture intrusion or other contamination in the sub-assembly; and
fastening the sub-assembly to the eyeglass frames.

90. The method of claim 89, wherein the closure means comprise a first housing and a second housing, and wherein assembling the sub-assembly comprises:
arranging the first housing around the first device part, such as to substantially enclose the first device part; and
arranging the second housing around the second device part, such as to substantially enclose the second device part.

91. The method of claim 89, wherein assembling the sub-assembly further comprises encapsulating the flexible cable with a compressible and/or elastic material

92. The method of claim 73, wherein providing the electronic device comprises providing an electronic device wherein the flexible cable comprises a flexible PCB.

93. A method of manufacturing an electronic pre-assembly for use in the method of claim 73, comprising the following steps:
providing an electronic device comprising a first device part, a second device part, and a flexible cable, preferably a flexible printed circuit board (PCB), configured to provide an electrical connection between the first device part and the second device part;
manufacturing a first housing and a second housing, wherein the first housing is shaped to fit at least partially in the first cavity and configured to enclose the first device part, and wherein the second housing is shaped to fit at least partially in the second cavity and configured to enclose the second device part;
arranging and sealing the first housing to enclose the first device part; and
arranging and sealing the second housing to enclose the second device part.

94. The method of claim 93, further comprising:
encapsulating the flexible cable by a compressible and/or elastic material such that the electronic device as a whole is substantially protected from moisture intrusion or other contamination.

95. The method of claim 94, further comprising providing at least one connector suitable for providing an electrical connection between the electronic device and an electro-optical component.

96. The electronic glasses of claim 51, wherein the groove parts are sealed off from the environment by lenses positioned on top of or slightly inside the respective groove parts thereby fully covering the groove parts.

97. The electronic glasses of claim 51, wherein if an electro-active lens comprises connection points provided at its radially outwardly directed circumferential surfaces, then the connector is arranged to directly contact the connection points, when the electroactive lens is positioned on top of or slightly inside the associated groove part.
